(19) United States
(12) Patent Application Publication
(10) Pub. No.: US 2017/0240742 A1
(43) Pub. Date: Aug. 24, 2017

(54) POLYPHENYLENE ETHER RESIN COMPOSITION

(71) Applicant: Asahi Kasei Chemicals Corporation, Tokyo (JP)

(72) Inventors: Toru YAMAGUCHI, Tokyo (JP); Akira MITSUI, Tokyo (JP)

(73) Assignee: Asahi Kasei Chemicals Corporation, Tokyo (JP)

(21) Appl. No.: 15/047,184

(22) Filed: Feb. 18, 2016

(51) Int. Cl. C08L 71/12

(52) U.S. Cl. CPC C08L 71/123

(57) ABSTRACT

It is intended to provide a polyphenylene ether resin composition that has favorable fluidity in molding while ensuring sufficiently high heat resistance and/or favorable mechanical properties. The present invention provides a polyphenylene ether resin composition comprising: 50% by mass or more and 99% by mass or less of a polyphenylene ether resin (A) having a reduced viscosity of 0.33 dl/g or more and 0.46 dl/g or less measured in an amount of 0.5 g/dl at 30° C. using a chloroform solvent; 0% by mass or more and 49% by mass or less of a polystyrene resin (B); and 1% by mass or more and 15% by mass or less of a styrene-acrylonitrile resin (C) having an acrylonitrile content of 16% by mass or more and 45% by mass or less.

### BACKGROUND OF THE INVENTION

Field of the Invention

The present invention relates to a polyphenylene ether resin composition.

Description of the Related Art

Polyphenylene ether (PPE) resins have diverse characters such as excellent mechanical properties, electrical characteristics, acid resistance, alkali resistance, and heat resistance as well as low specific gravity, low water absorptivity, and favorable dimensional stability and are therefore utilized as a wide range of materials for home electronics products, office automation equipment, business machines, information equipment, automobiles, etc. Particularly, for purposes requiring high heat resistance or rigidity, a demand for resin compositions designed with a further high content ratio of a polyphenylene ether resin promises to grow in the future. A higher content of a polyphenylene ether resin, however, tends to more significantly reduce fluidity in molding. Therefore, improvement in fluidity in molding has been demanded for the resin compositions designed with a high content ratio of a polyphenylene ether resin.

Heretofore, a method of adding polystyrene and a method of using a relatively low-molecular-weight polyphenylene ether resin have been known as a method for improving the fluidity in molding of a thermoplastic resin containing a polyphenylene ether resin. These approaches, however, have the difficulty in sufficiently improving fluidity in molding while maintaining the adequate heat resistance or mechanical properties of a resin composition.

Also, the fluidity in molding is known to be drastically improved by adding a resin, such as an AS (styrene-acrylonitrile copolymer) resin, which is not compatible with the polyphenylene ether resin, to a polyphenylene ether resin composition. Such a method, however, causes delamination in molded pieces, resulting in reduction in mechanical properties. Therefore, the method is very difficult to apply.

Meanwhile, an alternative method involves adding a resin component such as a petroleum resin or a terpene resin for thereby improving fluidity in molding without significantly reducing heat resistance (see e.g., Patent Literature 1). In addition, an alternative method involves adding an AS resin having a small AN (acrylonitrile) content to a resin composition containing polyphenylene ether and polystyrene for thereby improving fluidity in molding while preventing reduction in heat resistance (see e.g., Patent Literature 2).

### CITATION LIST

### Patent Literature

[Patent Literature 1] Japanese Patent No. 2945992

[Patent Literature 2] Japanese Patent No. 3745121

The techniques described in Patent Literature 1 and Patent Literature 2 are found to be effective for improving fluidity in molding to some extent. However, their effects are not always sufficient. These techniques have the difficulty in achieving excellent fluidity in molding, particularly, for highly heat-resistant resin compositions designed with a high content ratio of a polyphenylene ether resin.

The present invention has been made in light of these problems. An object of the present invention is to provide a polyphenylene ether resin composition that has favorable fluidity in molding while ensuring sufficiently high heat resistance and/or favorable mechanical properties.

### BRIEF SUMMARY OF THE INVENTION

Specifically, the present invention is as follows:

[1] A polyphenylene ether resin composition comprising:

50% by mass or more and 99% by mass or less of a polyphenylene ether resin (A) having a reduced viscosity of 0.33 dl/g or more and 0.46 dl/g or less measured in an amount of 0.5 g/dl at 30° C. using a chloroform solvent;

0% by mass or more and 49% by mass or less of a polystyrene resin (B); and

1% by mass or more and 15% by mass or less of a styrene-acrylonitrile resin (C) having an acrylonitrile content of 16% by mass or more and 45% by mass or less.

[2] The polyphenylene ether resin composition according to [1], wherein an amount of the component (B) is 5% by mass or more and 45% by mass or less with respect to the total amount of 100% by mass of the component (A), the component (B), and the component (C).
[3] The polyphenylene ether resin composition according to [1] or [2], further comprising 1 part by mass or more and 25 parts by mass or less of a styrene thermoplastic elastomer (D) with respect to the total amount of 100 parts by mass of the component (A), the component (B), and the component (C).

The polyphenylene ether resin composition of the present invention has favorable fluidity in molding while ensuring sufficiently high heat resistance and/or favorable mechanical properties. Therefore, the polyphenylene ether resin composition of the present invention can be favorably used, particularly, for molded articles for light-reflective parts, such as automobile lamp reflector or lamp extension molded articles.

### BRIEF DESCRIPTION OF THE DRAWING

FIG. 1 is a graph showing the relationship between the reduced viscosity of PPE and fluidity in molding based on Examples of the present invention and Comparative Examples.

### DETAILED DESCRIPTION OF THE INVENTION

Hereinafter, the embodiment for carrying out the present invention (hereinafter, referred to as the “present embodiment”) will be described in detail. However, the present invention is not intended to be limited by embodiments given below, and various changes or modifications can be made therein without departing from the spirit of the present invention.

### [Polyphenylene Ether Resin Composition]

The polyphenylene ether resin composition of the present embodiment contains: 50% by mass or more and 99% by mass or less of a polyphenylene ether resin (A) having a reduced viscosity of 0.33 dl/g or more and 0.46 dl/g or less measured in an amount of 0.5 g/dl at 30° C. using a chloroform solvent; 0% by mass or more and 49% by mass or less of a polystyrene resin (B); and 1% by mass or more and 15% by mass or less of a styrene-acrylonitrile (AS) resin (C) having an acrylonitrile (AN) content of 16% by mass or more and 45% by mass or less. The polyphenylene ether resin composition of the present embodiment thus constituted so as to contain the desired components in the desired amounts has favorable fluidity in molding while ensuring sufficiently high heat resistance and/or favorable mechanical properties.

### (Component (A))

In the present embodiment, the polyphenylene ether resin (A) has a reduced viscosity of 0.33 to 0.46 dl/g. The “reduced viscosity” of the polyphenylene ether resin (A) described herein refers to the reduced viscosity of the polyphenylene ether resin (component (A)) separated from the resin composition after melt kneading of the component (A), the component (B), the component (C), etc., unless otherwise specified. In short, the “reduced viscosity” is discriminated from the “original reduced viscosity possessed as physical properties by the starting material polyphenylene ether resin (A)”. In the case of preparing a resin composition containing polyphenylene ether by melt kneading, the reduced viscosity is increased after melt kneading compared with before melt kneading. In this context, the degree of this increase differs depending on preparation conditions. The present inventors have found that the reduced viscosity of the polyphenylene ether resin (A) in the form of a resin composition should be adjusted in order to allow the resin composition to exhibit the desired characters. The “reduced viscosity” of the polyphenylene ether resin (A) shall be measured in an amount of 0.5 g/dl at 30° C. using a chloroform solvent. The reduced viscosity of the polyphenylene ether resin (A) is more preferably in the range of 0.34 dl/g or more and 0.44 dl/g or less, further preferably in the range of 0.35 dl/g or more and 0.42 dl/g or less. The reduced viscosity of the polyphenylene ether resin after separation with a solvent from the resin composition is preferably 0.33 dl/g or more from the viewpoint of providing adequate mechanical properties and is preferably 0.46 dl/g or less from the viewpoint of providing adequate fluidity in molding and miscibility with the component (B). On the other hand, if the reduced viscosity is less than 0.33 dl/g, the adequate mechanical properties are not provided. If the reduced viscosity exceeds 0.46 dl/g, the adequate fluidity in molding is not provided.

In the present embodiment, the starting material polyphenylene ether resin is not particularly limited and is preferably a homopolymer having repeat units each represented by the following general formula (a) or (b) and consisting of the structural units of the general formula (a) or (b), or a copolymer thereof, from the viewpoint of the performance and productivity of the polymer:

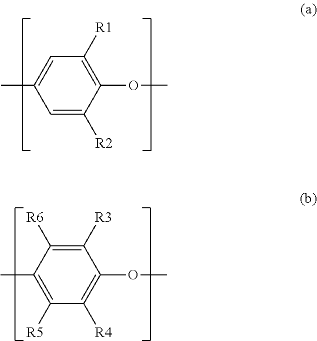

In the general formulae (a) and (b), R1, R2, R3, R4, R5, and R6 are each independently, preferably, a monovalent residue such as an alkyl group having 1 or more and 4 or less carbon atoms, an aryl group having 6 or more and 12 or less carbon atoms, halogen, and hydrogen from the viewpoint of the performance and productivity of the polymer, provided that R5 and R6 are not hydrogen atoms at the same time. Also from the viewpoint of the performance and productivity of the polymer, the number of carbon atoms in the alkyl group is more preferably 1 or more and 3 or less; the number of carbon atoms in the aryl group is more preferably 6 to 8; and among the monovalent residues mentioned above, hydrogen is more preferred. The number of repeat units each represented by the general formulae (a) and (b) varies depending on the molecular weight distribution of the polyphenylene ether resin and thus, is not particularly limited.

In the present embodiment, examples of the homopolymer of the polyphenylene ether resin (A) include, but are not limited to, poly(2,6-dimethyl-1,4-phenylene) ether, poly(2-methyl-6-ethyl-1,4-phenylene) ether, poly(2,6-diethyl-1,4-phenylene) ether, poly(2-ethyl-6-n-propyl-1,4-phenylene) ether, poly(2,6-di-n-propyl-1,4-phenylene) ether, poly(2-methyl-6-n-butyl-1,4-phenylene) ether, poly(2-ethyl-6-isopropyl-1,4-phenylene) ether, poly(2-methyl-6-chloroethyl-1,4-phenylene) ether, poly(2-methyl-6-hydroxyethyl-1,4-phenylene) ether, and poly(2-methyl-6-chloroethyl-1,4-phenylene) ether. Among them, poly(2,6-dimethyl-1,4-phenylene) ether is preferred from the viewpoint of the easy availability and workability of the starting material.

In the present embodiment, examples of the copolymer of the polyphenylene ether resin (A) include, but are not limited to, copolymers composed mainly of a polyphenylene ether structure, such as a copolymer of 2,6-dimethylphenol and 2,3,6-trimethylphenol, a copolymer of 2,6-dimethylphenol and o-cresol, and a copolymer of 2,3,6-trimethylphenol and o-cresol. Among them, a copolymer of 2,6-dimethylphenol and 2,3,6-trimethylphenol is preferred from the viewpoint of the easy availability and workability of the starting material. A copolymer obtained from 70% by mass or more and 90% by mass or less of 2,6-dimethylphenol and 10% by mass or more and 30% by mass or less of 2,3,6-trimethylphenol is more preferred from the viewpoint of improvement in physical properties.

In the present embodiment, these polyphenylene ether resins may each be used alone or may be used in combination of two or more thereof. The polyphenylene ether resin (A) may contain any of other various phenylene ether units as a partial structure without departing from the desired effects of the present embodiment. Examples of such phenylene ether units include, but are not limited to, a 2-(dialkylaminomethyl)-6-methylphenylene ether unit and a 2-(N-alkyl-N-phenylaminomethyl)-6-methylphenylene ether unit described in Japanese Patent Laid-Open Nos. H01-297428 and S63-301222.

In the present embodiment, a small amount of diphenoquinone, for example, may be bonded to the main chain of the polyphenylene ether resin. A portion or the whole of the polyphenylene ether resin may be converted to a functionalized polyphenylene ether resin by reaction (modification) with a functionalizing agent containing an acyl functional group and one or more selected from the group consisting of carboxylic acid, acid anhydride, acid amide, imide, amine, o-ester, hydroxy, and carboxylic acid ammonium salt.

In the present embodiment, the original reduced viscosity possessed as physical properties by the starting material polyphenylene ether resin is preferably in the range of 0.25 dl/g or more and 0.37 dl/g or less (measured in an amount of 0.5 g/dl at 30° C. using a chloroform solvent). The original reduced viscosity is more preferably in the range of 0.27 dl/g or more and 0.36 dl/g or less, further preferably in the range of 0.28 dl/g or more and 0.35 dl/g or less. The melt kneading to obtain the desired resin composition tends to increase the molecular weight of the polyphenylene ether resin compared with the molecular weight of the starting material and accordingly tends to increase the reduced viscosity. While depending on melt kneading conditions, the reduced viscosity of the starting material polyphenylene ether resin is preferably 0.25 dl/g or more and 0.37 dl/g or less for preparation under conditions mentioned later, because the reduced viscosity of the polyphenylene ether resin contained in the resin composition tends to easily become 0.33 dl/g or more and 0.46 dl/g or less. As for the specific measurement of the reduced viscosity, the polyphenylene ether resin obtained by separation with a solvent from the polyphenylene ether resin composition is dissolved in a chloroform solvent to prepare a 0.5 g/dl solution, which can then be measured under a temperature condition of 30° C. using an Ubbelohde viscometer.

In the present embodiment, the ratio of the weight-average molecular weight Mw to the number-average molecular weight Mn (Mw/Mn value) of the starting material polyphenylene ether resin is preferably 2.0 or more and 5.5 or less, more preferably 2.5 or more and 4.5 or less, further preferably 3.0 or more and 4.5 or less. The Mw/Mn value is preferably 2.0 or more from the viewpoint of improvement in the molding processability of the resin composition and is preferably 5.5 or less from the viewpoint of the mechanical properties of the resin composition. The weight-average molecular weight Mw and the number-average molecular weight Mn are obtained as polystyrene-based molecular weights by gel permeation chromatography (GPC) measurement.

In the present embodiment, the content of the polyphenylene ether resin (A) is in the range of 50% by mass or more and 99% by mass or less with respect to the total amount (100% by mass) of polyphenylene ether resin (A), polystyrene resin (B) and AS resin (C). The content of the polyphenylene ether resin (A) is preferably in the range of 60% by mass or more and 90% by mass or less, more preferably in the range of 65% by mass or more and 80% by mass or less. In the present embodiment, the content of the polyphenylene ether resin (A) is preferably 50% by mass or more from the viewpoint of conferring adequate heat resistance and is preferably 95% by mass or less from the viewpoint of maintaining adequate fluidity in molding. On the other hand, if the content of the component (A) is less than 50% by mass, the adequate heat resistance is not conferred.

### (Component (B))

In the present embodiment, the polystyrene resin (B) is a polymer obtained by polymerizing a styrene compound in the presence or absence of a rubber polymer. The styrene compound means a compound represented by the general formula (c):

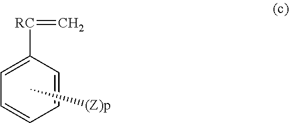

wherein R represents hydrogen, lower alkyl, or halogen; Z is selected from the group consisting of vinyl, hydrogen, halogen, and lower alkyl; and p is an integer of 0 to 5.

Specific examples of the styrene compound include, but are not particularly limited to, styrene, α-methylstyrene, 2,4-dimethylstyrene, monochlorostyrene, p-methylstyrene, p-tert-butylstyrene, and ethylstyrene. In the present embodiment, preferred examples of the polystyrene resin can include polystyrene and high-impact polystyrene reinforced with a rubber polymer component from the viewpoint of miscibility with polyphenylene ether. The high-impact polystyrene is particularly preferably partially hydrogenated high-impact polystyrene in which the rubber polymer component is partially hydrogenated, from the viewpoint of heat stability.

The resin composition of the present embodiment contains 0% by mass or more and 49% by mass or less of the polystyrene resin (B) with respect to the total amount (100% by mass) of polyphenylene ether resin (A), polystyrene resin (B) and AS resin (C). Thus, the component (B) can be regarded as an optional component for the polyphenylene ether resin composition of the present embodiment. In short, the polyphenylene ether resin composition of the present embodiment can provide the desired effects obtained from the other components, which are essential, even without being supplemented with the component (B). In the present embodiment, however, it is preferred to add the polystyrene resin (B) (to contain more than 0% by mass of the component (B)) from the viewpoint of molding processability, and to add 49% by mass or less of the polystyrene resin (B) from the viewpoint of maintaining adequate heat resistance. From similar viewpoints, the content of the polystyrene resin (B) is preferably in the range of 5% by mass or more and 45% by mass or less, more preferably in the range of 8% by mass or more and 35% by mass or less.

### (Component (C))

The polyphenylene ether resin composition of the present embodiment contains the AS resin (C), which has an AN content of 16% by mass or more and 45% by mass or less, in the range of 1% by mass or more and 15% by mass or less with respect to the total amount (100% by mass) of polyphenylene ether resin (A), polystyrene resin (B) and AS resin (C) from the viewpoint of sufficient improvement in fluidity in molding. The content of the AS resin (C) is preferably in the range of 2% by mass or more and 13% by mass or less, more preferably in the range of 3% by mass or more and 12% by mass or less. The content of the AS resin (C) is preferably 1% by mass or more from the viewpoint of improvement in the fluidity in molding of the polyphenylene ether resin composition according to the present embodiment, and is preferably 15% by mass or less from the viewpoint of the prevention of delamination of molded articles and the prevention of reduction in mechanical properties. The AN content of the AS resin (C) according to the present embodiment is selected from the range of 16% by mass or more and 45% by mass or less. The AN content is preferably in the range of 18% by mass or more and 40% by mass or less, more preferably in the range of 20% by mass or more and 35% by mass or less. The AN content of the AS resin (C) is 16% by mass or more from the viewpoint of improvement in the fluidity in molding of the resin composition and is 45% by mass or less from the viewpoint of heat stability. On the other hand, if the content of the component (C) is less than 1% by mass, the fluidity in molding is impaired. If the content of the component (C) exceeds 15% by mass, disadvantages emerge such as delamination of molded articles and reduction in mechanical properties. If the AN content of the AS resin is less than 16% by mass, the fluidity in molding is impaired. If the AN content of the AS resin exceeds 45% by mass, the heat stability is impaired.

The melt flow rate (MFR) of the AS resin (C) measured at 220° C. under a load of 10 kg is preferably in the range of 1 g/10 min or more and 50 g/10 min or less, more preferably in the range of 4 g/10 min or more and 40 g/10 min or less, further preferably in the range of 8 g/10 min or more and 30 g/10 min or less. The MFR is preferably 1 g/10 min or more from the viewpoint of fluidity in molding and is preferably 50 g/10 min or less from the viewpoint of ensuring moderate miscibility in the resin composition.

The AS resin (C) according to the present embodiment is not compatible with the polyphenylene ether resin (A) and contributes to the formation of a dispersed phase in the polyphenylene ether resin composition of the present embodiment.

The average particle size of dispersed particles of the AS resin (C) in a core layer portion of a molded article is preferably in the range of 0.05 μm or more and 1.8 μm or less. The average particle size is more preferably in the range of 0.1 μm or more and 1.5 μm or less, further preferably in the range of 0.2 μm or more and 1.0 μm or less. The average particle size is preferably 0.05 μm or more from the viewpoint of ensuring adequate fluidity in molding and is preferably 1.8 μm or less from the viewpoint of the prevention of peel in the molded article and improvement in the productivity of the resin composition. The “core layer” refers to a layer that is positioned at an internal site relatively close to the central portion of the molded article obtained from the resin composition of the present embodiment, and is composed of the resin composition containing the dispersed phase of the component (C). The average particle size of the dispersed particles can be measured by the image analysis of electron microscope photographs of the core (inside of the molded article) layer.

### (Component (D))

Preferably, the resin composition of the present embodiment further contains a styrene thermoplastic elastomer (D) at a proportion of 1 part by mass or more and 25 parts by mass or less with respect to the total amount (100 parts by mass) of the components (A), (B), and (C) from the viewpoint of improvement in the impact resistance of the resin composition. The content of the styrene thermoplastic elastomer (D) is more preferably in the range of 1 part by mass or more and 20 parts by mass or less, further preferably in the range of 2 parts by mass or more and 15 parts by mass or less. In the present embodiment, the content of the styrene thermoplastic elastomer (D) is preferably 1 part by mass or more from the viewpoint of conferring better impact resistance and is preferably 25 parts by mass or less from the viewpoint of ensuring adequate heat resistance and rigidity.

The styrene thermoplastic elastomer (D) is a hydrogenation product of a block copolymer having a styrene block and a conjugated diene compound block (hereinafter, also referred to as a “styrene block-conjugated diene compound block copolymer”). The conjugated diene compound block is preferably hydrogenated at a hydrogenation rate of at least 50% or more, more preferably 80% or more, further preferably 95% or more, from the viewpoint of heat stability. These styrene thermoplastic elastomers (D) may each be used alone or may be used in combination of two or more thereof.

Examples of the conjugated diene compound block include, but are not limited to, polybutadiene, polyisoprene, poly(ethylene-butylene), poly(ethylene-propylene), and vinyl-polyisoprene. These conjugated diene compound blocks may each be used alone or may be used in combination of two or more thereof.

The sequence pattern of the repeat units constituting the block copolymer may be linear type or radial type. The block structure constituted by a polystyrene block and an intermediate rubber block may be any of diblock, triblock, and tetrablock structures. Among others, a triblock linear-type block copolymer constituted by a polystyrene-poly(ethylene-butylene)-polystyrene structure is preferred from the viewpoint of being able to sufficiently provide the effects desired for the present embodiment. The conjugated diene compound block may contain an unhydrogenated butadiene unit in a range that does not exceed 30% by mass.

A functionalized styrene thermoplastic elastomer prepared by the introduction of a functional group such as a carbonyl group or an amino group to the styrene thermoplastic elastomer may be used.

The carbonyl group can be introduced thereto by modification with unsaturated carboxylic acid or a functional derivative thereof. Examples of the unsaturated carboxylic acid or the functional derivative thereof include, but are not limited to, maleic acid, fumaric acid, itaconic acid, halogenated maleic acid, cis-4-cyclohexene-1,2-dicarboxylic acid, and endo-cis-bicyclo[2,2,1]-5-heptene-2,3-dicarboxylic acid, and anhydrides, ester compounds, amide compounds, and imide compounds of these dicarboxylic acids. Further examples thereof include acrylic acid and methacrylic acid, and ester compounds and amide compounds of these monocarboxylic acids. Among others, maleic anhydride is preferred from the viewpoint of maintaining the surface appearance of molded articles and conferring impact resistance.

The amino group can be introduced to the styrene thermoplastic elastomer through reaction with an imidazolidinone compound, a pyrrolidone compound, or the like.

Preferably, the polyphenylene ether resin composition of the present embodiment contains a hydrogenation product of a styrene-conjugated diene compound block copolymer having an amount of bound styrene of 45% by mass or more and 80% by mass or less, from the viewpoint of maintaining the appearance of molded articles, conferring better impact resistance, and preventing delamination of molded articles.

### (Other Components Optionally Contained in Polyphenylene Ether Resin Composition)

Preferably, the resin composition of the present embodiment further contains a heat stabilizer at a proportion of 0.01 parts by mass or more and 1 part by mass or less with respect to the total amount (100 parts by mass) of the component (A), the component (B), and the component (C) from the viewpoint of improvement in the heat stability of the resin composition. The content of the heat stabilizer is more preferably in the range of 0.1 parts by mass or more and 0.5 parts by mass or less, further preferably in the range of 0.2 parts by mass or more and 0.5 parts by mass or less. In the present embodiment, the content of the heat stabilizer is preferably 0.01 parts by mass or more from the viewpoint of ensuring the adequate appearance of molded products and is preferably 1 part by mass or less from a similar viewpoint.

The melting point of the heat stabilizer according to the present embodiment is preferably 180° C. or more, more preferably 200° C. or more and 310° C. or less, further preferably 220° C. or more and 270° C. or more, from the viewpoint of adequate heat stability.

The heat stabilizer is preferably a hindered phenol or phosphorus heat stabilizer from the viewpoint of effects. Specific examples of the hindered phenol heat stabilizer include tris(2,4-di-tert-butylphenyl)phosphite, 3,3′,3″,5,5′,5″-hexa-tert-butyl-a,a′,a″-(mesitylene-2,4,6-triyl)tri-p-cresol, and 1,3,5-tris(3,5-di-tert-butyl-4-hydroxybenzyl)-1,3,5-triazine-2,4,6(1H,3H,5H)-trione. Specific examples of the phosphorus heat stabilizer include bis(2,4-dicumylphenyl)pentaerythritol diphosphite, and 3,9-bis(2,6-di-tert-butyl-4-methylphenoxy)-2,4,8,10-tetraoxa-3,9-diphosphapyro[5,5]undecane.

The polyphenylene ether resin composition according to the present embodiment can contain a phosphorus flame retardant at a proportion of 2 parts by mass or more and 25 parts by mass or less with respect to the total amount (100 parts by mass) of the component (A), the component (B), and the component (C) from the viewpoint of imparting better flame retardancy to the polyphenylene ether resin composition. The content of the flame retardant is preferably in the range of 3 parts by mass or more and 20 parts by mass or less, more preferably in the range of 5 parts by mass or more and 15 parts by mass or less. The content of the flame retardant is preferably 2 parts by mass or more from the viewpoint of conferring adequate flame retardancy and is preferably 25 parts by mass or less from the viewpoint of maintaining heat resistance. Specific examples of the phosphorus flame retardant can include, but are not limited to, phosphine, phosphine oxide, biphosphine, phosphonium salt, phosphinic acid salt, phosphazene, organic phosphoric acid ester, and organic phosphorous acid ester. Among others, an aromatic phosphoric acid ester flame retardant, a phosphazene flame retardant, or a phosphinic acid salt is preferably used in the present embodiment from the viewpoint of conferring adequate flame retardancy.

Specific examples of the aromatic phosphoric acid ester flame retardant include, but are not limited to, triphenyl phosphate, tricresyl phosphate, trixylenyl phosphate, cresyl diphenyl phosphate, dicresyl phenyl phosphate, hydroxyphenyl diphenyl phosphate, resorcinol bisdiphenyl phosphate, bisphenol A bisphosphate, and bisphenol A bisdiphenyl phosphate. Among them, triphenyl phosphate or bisphenol A bisphosphate is preferably used from the viewpoint of conferring adequate flame retardancy.

Specific examples of the phosphazene flame retardant include, but are not limited to, propoxy phosphazene, phenoxy phosphazene, amino phosphazene, and fluoroalkyl phosphazene. Among them, a cyclic phenoxy phosphazene compound is more preferably used from the viewpoint of conferring adequate flame retardancy.

Specific examples of the phosphinic acid salt include, but are not limited to, calcium dimethylphosphinate, magnesium dimethylphosphinate, aluminum dimethylphosphinate, zinc dimethylphosphinate, calcium ethylmethylphosphinate, magnesium ethylmethylphosphinate, aluminum ethylmethylphosphinate, zinc ethylmethylphosphinate, calcium diethylphosphinate, magnesium diethylphosphinate, aluminum diethylphosphinate, zinc diethylphosphinate, calcium methyl-n-propylphosphinate, magnesium methyl-n-propylphosphinate, aluminum methyl-n-propylphosphinate, zinc methyl-n-propylphosphinate, calcium methanedi(methylphosphinate), magnesium methanedi(methylphosphinate), aluminum methanedi(methylphosphinate), zinc methanedi(methylphosphinate), calcium benzene-1,4-(dimethylphosphinate), magnesium benzene-1,4-(dimethylphosphinate), aluminum benzene-1,4-(dimethylphosphinate), zinc benzene-1,4-(dimethylphosphinate), calcium methylphenylphosphinate, magnesium methylphenylphosphinate, aluminum methylphenylphosphinate, zinc methylphenylphosphinate, calcium diphenylphosphinate, magnesium diphenylphosphinate, aluminum diphenylphosphinate, and zinc diphenylphosphinate. Among them, aluminum diethylphosphinate is more preferably used from the viewpoint of easy availability and the conferring of adequate flame retardancy.

The polyphenylene ether resin composition of the present embodiment may contain an inorganic filler as a reinforcing agent at a proportion of 5 parts by mass or more and 45 parts by mass or less with respect to the total amount (100 parts by mass) of the component (A), the component (B), and the component (C) from the viewpoint of the further reinforcement of mechanical properties. The content of the inorganic filler is preferably in the range of 7 parts by mass or more and 40 parts by mass or less, more preferably in the range of 10 parts by mass or more and 30 parts by mass or less. The content of the inorganic filler is preferably 5 parts by mass or more from the viewpoint of conferring mechanical properties such as adequate rigidity and is preferably 45 parts by mass or less from the viewpoint of maintaining molding processability. An inorganic filler generally used in the reinforcement of thermoplastic resins can be used as such a reinforcing agent. Examples thereof include, but are not limited to, glass fibers, carbon fibers, glass flakes, talk, and mice.

### (Qualitative and Quantitative Determination of Each Component)

In the polyphenylene ether resin composition of the present embodiment, the component (A), the component (B), the component (C), and other components contained therein can be determined qualitatively and quantitatively by a separation and extraction operation using a solvent or analysis using high-performance liquid chromatography (HPLC).

Specifically, each component can be determined qualitatively and quantitatively, for example, by the following method: first, the polyphenylene ether resin composition is dissolved in chloroform at ordinary temperature to 50° C. to prepare a 1 to 5% by mass solution, followed by the separation of insoluble matter such as inorganic matter by use of filtration or a centrifuge. Next, the polymer components are reprecipitated by the addition of an approximately 3-fold amount of methanol to the chloroform solution to separate the polymer components including the component (A), the component (C), and the optional components (B) and (D) from soluble components such as additives. The polymer components are dried and then dissolved in dichloromethane heated to 50° C. to obtain a 1 to 5% by mass solution. Then, this solution is left in a freezer of −30° C. for 24 hours to deposit and separate the component (A), which is in turn dried and then quantified. The reduced viscosity is measured using the component (A) obtained by this operation as a sample. Next, the polymer components including the component (B), the component (C), and the component (D) are deposited by the addition of an approximately 3-fold amount of methanol to the dichloromethane solution containing the component (B), the component (C), and the component (D). The component (D) is removed from the deposited polymer components, and the resulting components are dried. Then, an acetone solution containing the component (B) and the component (C) in acetone is dried for the volatilization of acetone. The dried polymer components including the component (B) and the component (C) are quantified.

The dried polymer components including the component (B) and the component (C) are dissolved in tetrahydrofuran. The compositional ratios of the component (B) and the component (C) are determined by high-performance liquid chromatography (e.g., HPLC manufactured by Shimadzu Corp., column: silica-based product treated with cyanopropyl, developing solvent: tetrahydrofuran/n-heptane) to quantify each of the component (B) and the component (C). The calibration curve of the relationship between AN contents and retention times is prepared in advance by nitrogen analysis using standard samples having known AN contents (% by mass). The measurement samples are separated by HPLC (detector: 254 nm, UV), and the compositional ratios can be determined from the retention times of their peaks and the area ratios of the peaks.

### [Method for Preparing Resin Composition]

The polyphenylene ether resin composition of the present embodiment can be prepared, for example, by melt-kneading the aforementioned starting materials such as the component (A), the component (B), and the component (C). The melt kneading of the component (A), the component (B), and the component (C) for preparing the polyphenylene ether resin composition is preferably carried out using a twin-screw extruder from the viewpoint of stably obtaining the resin composition at a large scale. The set cylinder temperature of the twin-screw extruder is selected from the range of 260° C. or more and 340° C. or less. The set cylinder temperature of the twin-screw extruder is preferably 270° C. or more and 330° C. or less, more preferably 270° C. or more and 320° C. or less. The set cylinder temperature of the twin-screw extruder is preferably 260° C. or more from the viewpoint of sufficient melt kneading and is preferably 340° C. or less from the viewpoint of the suppression of thermal resin degradation. The number of screw rotations of the twin-screw extruder is selected from the range of 150 rpm or more and 600 rpm or less. The number of screw rotations of the twin-screw extruder is preferably 200 rpm or more and 500 rpm or less, more preferably 250 rpm or more and 400 rpm or less. The number of screw rotations of the twin-screw extruder is preferably 150 rpm or more from the viewpoint of sufficient melt kneading and is preferably 600 rpm or less from the viewpoint of the suppression of thermal resin degradation. The extruded resin temperature is selected from the range of 300° C. or more and 360° C. or less. The extruded resin temperature is preferably 320° C. or more and 350° C. or less, more preferably 320° C. or more and 340° C. or less. The extruded resin temperature is desirably 300° C. or more from the viewpoint of sufficient melt kneading and is desirably 360° C. or less from the viewpoint of the suppression of thermal resin degradation. It is also preferred to carry out deaeration using a vacuum vent line during extrusion from the viewpoint of the appearance (suppression of silver generation) of molded articles.

One example of the melt kneading method includes a melt kneading method using a twin-screw extruder TEM58SS (manufactured by Toshiba Machine Co., Ltd.; the number of barrels: 13, screw diameter: 58 mm, screw length L (mm)/screw diameter D (mm)=53, screw pattern having 2 kneading disks L, 14 kneading disks R, and 2 kneading disks N) under conditions involving a cylinder temperature of 270° C. or more and 330° C. or less, the number of screw rotations of 250 rpm or more and 500 rpm or less, and a degree of vent vacuum of 11.0 kPa or more and 1.0 kPa or less.

In the preparation method mentioned above, the reduced viscosity (measured at a temperature of 30° C. using an Ubbelohde viscometer and a 0.5 g/dl solution prepared by dissolving, in a chloroform solvent, the polyphenylene ether resin obtained by separation with a solvent from the polyphenylene ether resin composition) of the polyphenylene ether resin in the polyphenylene ether resin composition of the present embodiment is adjusted to within the range of 0.33 dl/g or more and 0.46 dl/g or less.

The reduced viscosity of the polyphenylene ether resin is increased during melt kneading. Therefore, a polyphenylene ether resin (powder) having a reduced viscosity lower than the desired reduced viscosity of the present embodiment is preferably used as the starting material.

This rise in the reduced viscosity of the polyphenylene ether resin during the melt kneading is influenced by the composition of the resin composition, melt kneading conditions, etc. The rise is found in the range of approximately 0.02 to approximately 0.09 by the adoption of the preferred extrusion conditions mentioned above. Subsequent processes such as molding rarely cause a rise in the reduced viscosity of the polyphenylene ether resin in the resin composition. Therefore, the reduced viscosity of the polyphenylene ether resin used as the starting material is preferably in the range of approximately 0.25 dl/g or more and approximately 0.37 dl/g or less from the viewpoint of the adjustment of the reduced viscosity of the polyphenylene ether resin in the resin composition after the melt kneading.

When the polyphenylene ether resin composition of the present embodiment is prepared using a large (screw diameter: 40 to 90 mm) twin-screw extruder, extruded resin pellets may be contaminated with gels or carbides generated from the component (A) resulting from extrusion, which may cause reduction in the surface appearance or luminance of molded articles. Thus, from the viewpoint of preventing the contamination with these gels or carbides derived from the component (A), it is preferred to add the component (A) from a top feed starting material inlet and to set the internal oxygen concentration of a shooter in the top feed inlet to 15% by volume or less. From a similar viewpoint, the internal oxygen concentration of a shooter is more preferably 8% by volume or less, further preferably 1% by volume or less.

The oxygen concentration mentioned above can be adjusted by sufficiently purging a starting material storage hopper with nitrogen, hermetically closing a feed line from the starting material storage hopper to the starting material inlet of the extruder so as to prevent air from coming from or going into the feed line, and then carrying out the adjustment of nitrogen feeds, the adjustment of the degree of opening of a gas vent port, etc.

### EXAMPLES

Hereinafter, the present embodiment will be described further specifically with reference to Examples and Comparative Examples. However, the present embodiment is not intended to be limited by these Examples. Methods for measuring physical properties and starting materials used in Examples and Comparative Examples will be given below.

### [Methods for Measuring Physical Properties]

### 1. Deflection Temperature Under Load (DTUL)

Pellets of a resin composition obtained by procedures mentioned later in detail were dried for 3 hours in a hot-air dryer of 120° C. The resin composition thus dried was molded into a multipurpose test specimen A-type dumbbell molded piece according to ISO3167 using an injection molding machine (IS-80EPN, manufactured by Toshiba Machine Co., Ltd.) equipped with an ISO physical property test specimen mold under conditions involving a cylinder temperature of 320° C., a mold temperature of 120° C., an injection pressure of 70 MPa (gauge pressure), an injection rate of 200 mm/sec, and injection time/cooling time=20 sec/20 sec. Subsequently, the obtained molded piece was cut to prepare an 80 mm×10 mm×4 mm test specimen. This test specimen was used in the measurement of the deflection temperature under load (DTUL) of 1.82 MPa by the flat wise method according to ISO75. The measurement apparatus used for DTUL was an automatic heat distortion tester (manufactured by Toyo Seiki Seisaku-Sho, Ltd.). In evaluation criteria, a higher value of DTUL meant to be more advantageous for the design of materials for the desired purposes of the present embodiment.

### 2. Fluidity in Molding (SSP)

Pellets of an obtained resin composition were dried for 3 hours in a hot-air dryer of 120° C. The resin composition thus dried was used to determine the SSP (short shot pressure), i.e., the minimum injection pressure by which the sample can be molded (filled up in the mold), of a 1.6 mm strip molded piece using an injection molding machine (IS-80EPN, manufactured by Toshiba Machine Co., Ltd.) equipped with a UL 1.6 mm thick strip test specimen mold under conditions involving a cylinder temperature of 320° C., a mold temperature of 120° C., an injection rate (panel-set value) of 32%, the number of screw rotations (panel-set value) of 38%, a measure of 24 mm, and injection time/cooling time=20 sec/20 sec. A gauge pressure value at a pressure gage indicating the injection pressure during molding of the injection molding machine was adopted as the value of SSP. In evaluation criteria, a smaller numeric value of SSP meant more favorable fluidity in molding.

### 3. Tensile Strength and Tensile Elongation

The ISO3167 multipurpose test specimen A-type dumbbell molded piece obtained as described above was subjected to a tensile test using Autograph (AG-5000, manufactured by Shimadzu Corp.) under conditions involving 115 mm distance between chucks and a testing rate of 50 mm/min to determine the tensile strength and the tensile elongation. The tensile test was conducted according to ISO527. The tensile elongation was determined from the rate of elongation of the test specimen between 50 mm gage markers. Larger values of both tensile strength and tensile elongation meant more favorable mechanical properties.

### 4. Peel of Molded Piece Gate Portion (Visual Observation)

The ISO3167 multipurpose test specimen A-type dumbbell molded piece obtained as described above was subjected to a peel test by the bending (peel off) of the knob at the gate side of the molded piece using nippers to visually determine the presence or absence (◯ and X) of delamination at the fracture surface. ◯ (delamination was absent) meant that the sample can be preferably used for the desired purposes of the present embodiment.

### 5. Reduced Viscosity

The reduced viscosity of the polyphenylene ether resin separated with a solvent was determined for each sample on the basis of the method described in above paragraph [0053]. The reduced viscosity of the starting material polyphenylene ether resin was also determined in the same way as above.

### [Starting Materials]

### <Polyphenylene Ether Resin (A)>

### (PPE1)

Poly(2,6-dimethyl-1,4-phenylene) ether having a reduced viscosity (measured at 30° C. using a chloroform solvent) of 0.28 dl/g was used (in the description below and the table, also simply referred to as “PPE1”).

### (PPE2)

Poly(2,6-dimethyl-1,4-phenylene) ether having a reduced viscosity (measured at 30° C. using a chloroform solvent) of 0.34 dl/g was used (in the description below and the table, also simply referred to as “PPE2”).

### (PPE3)

Poly(2,6-dimethyl-1,4-phenylene) ether having a reduced viscosity (measured at 30° C. using a chloroform solvent) of 0.42 dl/g was used (in the description below and the table, also simply referred to as “PPE3”).

### (PPE4)

Poly(2,6-dimethyl-1,4-phenylene) ether having a reduced viscosity (measured at 30° C. using a chloroform solvent) of 0.51 dl/g was used (in the description below and the table, also simply referred to as “PPE4”).

### <Polystyrene Resin (B)>

GPPS (general-purpose polystyrene, trade name: Polystyrene 680 (registered trademark), manufactured by Asahi Kasei Chemicals Corp.) was used (in the description below and the table, simply referred to as “GPPS”).

### <AS Resin (C)>

### (AS1)

An AS resin having an AN content of 29% by mass (trade name: Stylac AS 783 (registered trademark), manufactured by Asahi Kasei Chemicals Corp.; MFR: 9) was used (in the example and the table, simply referred to as “AS1”).

### (AS2)

An AS resin having an AN content of 20% by mass (trade name: Stylac AS T8707 (registered trademark), manufactured by Asahi Kasei Chemicals Corp.; MFR: 30) was used (in the example and the table, simply referred to as “AS2”).

An AS resin having an AN content of 40% by mass (trade name: Stylac AS 727 (registered trademark), manufactured by Asahi Kasei Chemicals Corp.; MFR: 12) was used (in the example and the table, simply referred to as “AS3”).

### <Styrene Thermoplastic Elastomer (D)>

An elastomer (trade name: Tuftec H1272 (registered trademark), manufactured by Asahi Kasei Chemicals Corp.: a hydrogenation product of a block copolymer having a styrene block and a conjugated diene compound block; amount of bound styrene: 35% by mass, hydrogenation rate: 95% or more) was used (in the description below and the table, simply referred to as “elastomer”).

### Comparative Example 1

70% by mass of PPE1, 10% by mass of GPPS, 12% by mass of AS1, and 8% by mass of elastomer were collectively blended, then supplied from a top feed of a twin-screw extruder ZSK25 (manufactured by Werner & Pfleiderer Industrielle Backtechnik GmbH, Germany; the number of barrels: 10, screw diameter: 25 mm, screw pattern having 2 kneading disks L, 6 kneading disks R, and 2 kneading disks N), and melt-kneaded under conditions involving a cylinder temperature of 300° C., the number of screw rotations of 300 rpm, an extrusion rate of 15 kg/hr, and a degree of vent vacuum of 7.998 kPa (60 torr) to obtain a polyphenylene ether resin composition. After the melt kneading of these components in the extruder, a resin strand extruded from the extruder outlet (dice head) was cut with a pelletizer to obtain pellets of the resin composition. The polyphenylene ether resin was separated with a solvent from the obtained polyphenylene ether resin composition, and its reduced viscosity was measured and consequently, was 0.31 dl/g. Results of measuring other physical properties of the obtained polyphenylene ether resin composition are shown in Table 1 below.

### Example 1

A polyphenylene ether resin composition was obtained by melt kneading in the extruder in the same way as in Comparative Example 1 except that PPE1 was replaced with PPE2. The polyphenylene ether resin was separated with a solvent from the obtained polyphenylene ether resin composition, and its reduced viscosity was measured and consequently, was 0.38 dl/g. Results of measuring other physical properties of the obtained polyphenylene ether resin composition are shown in Table 1 below.

### Comparative Example 2

A polyphenylene ether resin composition was obtained by melt kneading in the extruder in the same way as in Comparative Example 1 except that PPE1 was replaced with PPE3. The polyphenylene ether resin was separated with a solvent from the obtained polyphenylene ether resin composition, and its reduced viscosity was measured and consequently, was 0.48 dl/g. Results of measuring other physical properties of the obtained polyphenylene ether resin composition are shown in Table 1 below.

### Comparative Example 3

A polyphenylene ether resin composition was obtained by melt kneading in the extruder in the same way as in Comparative Example 1 except that PPE1 was replaced with PPE4. The polyphenylene ether resin was separated with a solvent from the obtained polyphenylene ether resin composition, and its reduced viscosity was measured and consequently, was 0.63 dl/g. Results of measuring other physical properties of the obtained polyphenylene ether resin composition are shown in Table 1 below.

### Comparative Example 4

74% by mass of PPE2, 18% by mass of GPPS, and 8% by mass of elastomer were collectively blended and then melt-kneaded in the extruder in the same way as in Comparative Example 1 to obtain a polyphenylene ether resin composition. The polyphenylene ether resin was separated with a solvent from the obtained polyphenylene ether resin composition, and its reduced viscosity was measured and consequently, was 0.38 dl/g. Results of measuring other physical properties of the obtained polyphenylene ether resin composition are shown in Table 1 below.

### Comparative Example 5

A polyphenylene ether resin composition was obtained by melt kneading in the extruder in the same way as in Comparative Example 4 except that PPE2 was replaced with PPE3. The polyphenylene ether resin was separated with a solvent from the obtained polyphenylene ether resin composition, and its reduced viscosity was measured and consequently, was 0.48 dl/g. Results of measuring other physical properties of the obtained polyphenylene ether resin composition are shown in Table 1 below.

### Comparative Example 6

A polyphenylene ether resin composition was obtained by melt kneading in the extruder in the same way as in Comparative Example 4 except that PPE2 was replaced with PPE4. The polyphenylene ether resin was separated with a solvent from the obtained polyphenylene ether resin composition, and its reduced viscosity was measured and consequently, was 0.63 dl/g. Results of measuring other physical properties of the obtained polyphenylene ether resin composition are shown in Table 1 below.

### Comparative Example 7

70% by mass of PPE2, 4% by mass of GPPS, 18% by mass of AS1, and 8% by mass of elastomer were collectively blended and then melt-kneaded in the extruder in the same way as in Comparative Example 1 to obtain a polyphenylene ether resin composition. The polyphenylene ether resin was separated with a solvent from the obtained polyphenylene ether resin composition, and its reduced viscosity was measured and consequently, was 0.38 dl/g. Results of measuring other physical properties of the obtained polyphenylene ether resin composition are shown in Table 1 below.

### Example 2

52.5% by mass of PPE1, 17.5% by mass of PPE4, 10% by mass of GPPS, 12% by mass of AS1, and 8% by mass of elastomer were collectively blended and then melt-kneaded in the extruder in the same way as in Comparative Example 1 to obtain a polyphenylene ether resin composition. The polyphenylene ether resin was separated with a solvent from the obtained polyphenylene ether resin composition, and its reduced viscosity was measured and consequently, was 0.38 dl/g. Results of measuring other physical properties of the obtained polyphenylene ether resin composition are shown in Table 1 below.

### Example 3

80% by mass of PPE2, 14% by mass of AS1, and 6% by mass of elastomer were collectively blended, then supplied from a top feed of a twin-screw extruder ZSK25 (manufactured by Werner & Pfleiderer Industrielle Backtechnik GmbH, Germany; the number of barrels: 10, screw diameter: 25 mm, screw pattern having 2 kneading disks L, 6 kneading disks R, and 2 kneading disks N), and melt-kneaded under conditions involving a cylinder temperature of 320° C., the number of screw rotations of 300 rpm, an extrusion rate of 10 kg/hr, and a degree of vent vacuum of 7.998 kPa (60 torr) to obtain a polyphenylene ether resin composition. The polyphenylene ether resin was separated with a solvent from the obtained polyphenylene ether resin composition, and its reduced viscosity was measured and consequently, was 0.43 dl/g. Results of measuring other physical properties of the obtained polyphenylene ether resin composition are shown in Table 1 below.

### Example 4

80% by mass of PPE2, 5% by mass of GPPS, 7% by mass of AS1, and 8% by mass of elastomer were collectively blended and then melt-kneaded in the extruder in the same way as in Example 3 to obtain a polyphenylene ether resin composition. The polyphenylene ether resin was separated with a solvent from the obtained polyphenylene ether resin composition, and its reduced viscosity was measured and consequently, was 0.43 dl/g. Results of measuring other physical properties of the obtained polyphenylene ether resin composition are shown in Table 1 below.

### Example 5

80% by mass of PPE1, 5% by mass of GPPS, 7% by mass of AS1, and 8% by mass of elastomer were collectively blended, then supplied from a top feed of a twin-screw extruder ZSK25 (manufactured by Werner & Pfleiderer Industrielle Backtechnik GmbH, Germany; the number of barrels: 10, screw diameter: 25 mm, screw pattern having 2 kneading disks L, 6 kneading disks R, and 2 kneading disks N), and melt-kneaded under conditions involving a cylinder temperature of 320° C., the number of screw rotations of 450 rpm, an extrusion rate of 10 kg/hr, and a degree of vent vacuum of 7.998 kPa (60 torr) to obtain a polyphenylene ether resin composition. The polyphenylene ether resin was separated with a solvent from the obtained polyphenylene ether resin composition, and its reduced viscosity was measured and consequently, was 0.34 dl/g. Results of measuring other physical properties of the obtained polyphenylene ether resin composition are shown in Table 1 below.

### Example 6

62.5% by mass of PPE1, 27.5% by mass of PPE3, 5% by mass of AS1, and 5% by mass of elastomer were collectively blended and then melt-kneaded in the extruder in the same way as in Comparative Example 1 to obtain a polyphenylene ether resin composition. The polyphenylene ether resin was separated with a solvent from the obtained polyphenylene ether resin composition, and its reduced viscosity was measured and consequently, was 0.45 dl/g. Results of measuring other physical properties of the obtained polyphenylene ether resin composition are shown in Table 1 below.

### Example 7

A polyphenylene ether resin composition was obtained by melt kneading in the extruder in the same way as in Example 6 except that AS1 was replaced with 12% by mass of AS2. The polyphenylene ether resin was separated with a solvent from the obtained polyphenylene ether resin composition, and its reduced viscosity was measured and consequently, was 0.38 dl/g. Results of measuring other physical properties of the obtained polyphenylene ether resin composition are shown in Table 1 below.

### Example 8

A polyphenylene ether resin composition was obtained by melt kneading in the extruder in the same way as in Example 7 except that AS2 was replaced with AS3. The polyphenylene ether resin was separated with a solvent from the obtained polyphenylene ether resin composition, and its reduced viscosity was measured and consequently, was 0.38 dl/g. Results of measuring other physical properties of the obtained polyphenylene ether resin composition are shown in Table 1 below.

TABLE 1

| | | Example | Example | Example | Example | Example | Example | Example | Example |
|---|---|---|---|---|---|---|---|---|---|
| | | 1 | 2 | 3 | 4 | 5 | 6 | 7 | 8 |
| Starting | PPE1 (Component A: | | 52.5 | | | 80 | 62.5 | | |
| material | η = 0.28, Mw/Mn = 1.99) | | | | | | | | |
| (part by | PPE2 (Component A: | 70 | | 80 | 80 | | | 70 | 70 |
| mass) | η = 0.34, Mw/Mn = 2.11) | | | | | | | | |
| | PPE3 (Component A: | | | | | | 27.5 | | |
| | η = 0.42, Mw/Mn = 2.43) | | | | | | | | |
| | PPE4 (Component A: | | 17.5 | | | | | | |
| | η = 0.51, Mw/Mn = 2.72) | | | | | | | | |
| | GPPS (Component B) | 10 | 10 | | 5 | 5 | | 10 | 10 |
| | AS1 (Component C: AN29%) | 12 | 12 | 14 | 7 | 7 | 5 | | |
| | AS2 (Component C: AN20%) | | | | | | | 12 | |
| | AS3 (Component C: AN40%) | | | | | | | | 12 |
| | Elastomer (Component D) | 8 | 8 | 6 | 8 | 8 | 5 | 8 | 8 |
| Physical | DTUL (° C.) | 147 | 147 | 166 | 165 | 165 | 178 | 147 | 149 |
| property of | SSP (kgf/cm²) | 12 | <10 | 48 | 44 | <10 | 78 | 12 | 14 |
| composition | Tensile strength (MPa) | 75 | 77 | 77 | 78 | 77 | 73 | 78 | 77 |
| | Tensile elongation (%) | 12.3 | 14.2 | 14.4 | 12.8 | 12.2 | 10.5 | 15.4 | 14.7 |
| | Pass/failure results | ◯ | ◯ | ◯ | ◯ | ◯ | ◯ | ◯ | ◯ |
| | of peel test | | | | | | | | |
| | PPE reduced viscosity | 0.38 | 0.38 | 0.43 | 0.43 | 0.34 | 0.45 | 0.38 | 0.38 |
| | in composition (dl/g) | | | | | | | | |

| | | Comparative | Comparative | Comparative | Comparative | Comparative | Comparative | Comparative |
|---|---|---|---|---|---|---|---|---|
| | | example 1 | example 2 | example 3 | example 4 | example 5 | example 6 | example 7 |
| Starting | PPE1 (Component A: | 70 | | | | | | |
| material | η = 0.28, Mw/Mn = 1.99) | | | | | | | |
| (part by | PPE2 (Component A: | | | | 74 | | | 70 |
| mass) | η = 0.34, Mw/Mn = 2.11) | | | | | | | |
| | PPE3 (Component A: | | 70 | | | 74 | | |
| | η = 0.42, Mw/Mn = 2.43) | | | | | | | |
| | PPE4 (Component A: | | | 70 | | | 74 | |
| | η = 0.51, Mw/Mn = 2.72) | | | | | | | |
| | GPPS (Component B) | 10 | 10 | 10 | 18 | 18 | 18 | 4 |
| | AS1 (Component C: AN29%) | 12 | 12 | 12 | | | | 18 |
| | AS2 (Component C: AN20%) | | | | | | | |
| | AS3 (Component C: AN40%) | | | | | | | |
| | Elastomer (Component D) | 8 | 8 | 8 | 8 | 8 | 8 | 8 |
| Physical | DTUL (° C.) | 142 | 147 | 147 | 147 | 148 | 148 | 154 |
| property of | SSP (kgf/cm²) | <10 | 56 | 85 | 57 | 81 | 108 | 21 |
| composition | Tensile strength (MPa) | 64 | 76 | 77 | 75 | 76 | 77 | 72 |
| | Tensile elongation (%) | 1.3 | 9.0 | 5.4 | 4.8 | 6.0 | 7.6 | 3.4 |
| | Pass/failure results | X | X | X | ◯ | ◯ | ◯ | X |
| | of peel test | (fragile) | | | | | | |
| | PPE reduced viscosity | 0.31 | 0.48 | 0.63 | 0.38 | 0.48 | 0.63 | 0.38 |
| | in composition (dl/g) | | | | | | | |

As shown in Table 1, the polyphenylene ether resin compositions of Examples 1 to 8 each containing the component (A) and the component (C) in the desired ranges are evaluated as being free from delamination of molded pieces and reduction in mechanical properties, having favorable fluidity in molding and heat resistance, and having excellently balanced physical properties. By contrast, the composition of Comparative Example 1 containing the polyphenylene ether resin having a reduced viscosity that fell below the range specified by the present application yields a fragile molded piece and exhibits reduction in DTUL, tensile strength, and tensile elongation. The compositions of Comparative Examples 2 and 3 each containing the polyphenylene ether resin having a reduced viscosity that exceeded the range specified by the present application have inadequate fluidity in molding and both tend to cause delamination in molded pieces. All of the compositions of Comparative Examples 4 to 6 containing no component (C) have inadequate fluidity in molding. The reduced viscosity of the polyphenylene ether resin contained in each of the compositions of Comparative Examples 5 and 6 exceeded the desired range of the present embodiment. The composition of Comparative Example 7 containing the component (C) at a content that exceeded the desired range causes delamination in molded pieces and exhibits reduction in mechanical properties (tensile strength).

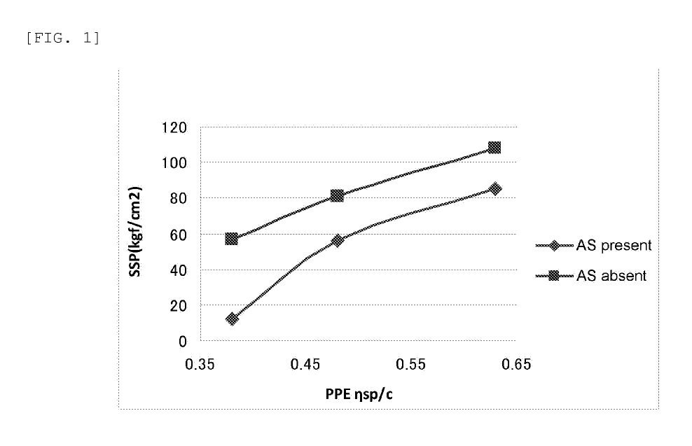

The relationship between the reduced viscosity (ηsp/c) of PPE (polyphenylene ether resin) and fluidity in molding (SSP) is summarized in the graph of FIG. 1 from the data on Example 1 and Comparative Examples 2 to 6 and will be described below. The graph relates to the influence of the presence or absence of AS on the polyphenylene ether resin composition. The plot of Comparative Examples 4 to 6 in the absence of AS (in FIG. 1, AS absent) demonstrated that the fluidity in molding indicated by the value of SSP tends to be improved as the reduced viscosity of PPE is decreased within the desired range of the PPE reduced viscosity of the present embodiment. Contrary to this, the plot of Example 1 and Comparative Examples 2 and 3 in the presence of AS demonstrated that the value of SSP tends to be decreased largely as compared with the absence of AS, as the reduced viscosity of PPE is decreased within the desired range of the PPE reduced viscosity of the present embodiment. These results demonstrated that, in the presence of AS, the fluidity in molding tends to be significantly improved with decrease in the reduced viscosity of PPE within the desired range of the PPE reduced viscosity of the present embodiment, as compared with the absence of AS.

The resin composition of the present invention maintains high heat resistance and favorable mechanical properties and has non-conventionally favorable fluidity in molding. Therefore, the resin composition can be favorably used, particularly, for molded articles for light-reflective parts, such as automobile lamp reflector or lamp extension molded articles.

1. A polyphenylene ether resin composition comprising:
50% by mass or more and 99% by mass or less of a polyphenylene ether resin (A) having a reduced viscosity of 0.33 dl/g or more and 0.46 dl/g or less measured in an amount of 0.5 g/dl at 30° C. using a chloroform solvent;
0% by mass or more and 49% by mass or less of a polystyrene resin (B); and
1% by mass or more and 15% by mass or less of a styrene-acrylonitrile resin (C) having an acrylonitrile content of 16% by mass or more and 45% by mass or less.

2. The polyphenylene ether resin composition according to claim 1, wherein an amount of the component (B) is 5% by mass or more and 45% by mass or less with respect to the total amount of 100% by mass of the component (A), the component (B), and the component (C).

3. The polyphenylene ether resin composition according to claim 1, further comprising 1 part by mass or more and 25 parts by mass or less of a styrene thermoplastic elastomer (D) with respect to the total amount of 100 parts by mass of the component (A), the component (B), and the component (C).

4. The polyphenylene ether resin composition according to claim 2, further comprising 1 part by mass or more and 25 parts by mass or less of a styrene thermoplastic elastomer (D) with respect to the total amount of 100 parts by mass of the component (A), the component (B), and the component (C).
